(19) United States
(12) Patent Application Publication
(10) Pub. No.: US 2010/0172687 A1
(43) Pub. Date: Jul. 8, 2010

(54) ERASER AND MARKER HOLDER FOR WHITE BOARDS

(75) Inventors: Miguel Angel Silva Rubio, Naucalpan (MX); Mauricio Enrique Ferrusca Ceja, Mexico D.F. (MX)

Correspondence Address: FSB FisherBroyles, a Limited Liability Partnership, The Pinnacle Building, 3455 Peachtree Road, NE Fifth Floor, Atlanta, GA, 30326, US

(73) Assignee: Grupo Azor Mexico, S.A. de C.V., Mexico D.F. (MX)

(21) Appl. No.: 12/499,258

(22) Filed: Jul. 8, 2009

(30) Foreign Application Priority Data
Sep. 25, 2008 (MX) MX/U/2008/000311

(51) Int. Cl. B43K 29/00; B43L 19/00

(52) U.S. Cl. 401/52; 15/425; 401/195

(57) ABSTRACT

The present invention refers to a device or article that can be used to carry or move one eraser and many markers, with the necessary means to support this article on a flat surface, such as a wall, a blackboard, a table or a similar surface, in such a way that both the eraser and the markers can be perfectly located by the user during a working session. In the embodiment illustrated, the article has the capacity to hold one eraser and up to three conventional markers.

### CLAIM OF PRIORITY

This application claims priority from Mexican patent application MX/u/2008/000311, “Eraser And Marker Holder For White Boards,” filed Sep. 25, 2008.

### TECHNICAL FIELD

The present invention is related with writing instruments, such as those used for white boards that require special markers as well as special erasers; especially the present invention is directed to an object that allows for the storage and transportation of an eraser and various markers, as well as maintaining them within arm's reach of the user of the board.

### BACKGROUND OF THE INVENTION

In recent years, the use of white boards and therefore the use of dry erase markers required for their use have become more popular every day. Many of the markers are designed to be used on relatively non porous surfaces, such as Mylar, plastic film, porcelain, or surfaces similar to that of the porcelain and of other similar surfaces. A common term for these boards and walls with this type of surface is “white board”. To write on this white board, various types of markers are used. Typically, the markers for white boards have a special formula that substantially impedes the ink from permanently adhering to the non porous surface being written on. This ink dries on the surface of the white board leaving a thin film. Previously, in order to erase the dry ink of the marker, the materials used in the erasers have been similar to those that were used in the erasers for chalk boards. The dry ink is erased relatively easily with a variety of materials and devices but the most common is to use an eraser with bristles made of many different materials such as felt, cloth or including being able to be erased with the hand of the user.

Traditionally, one of the main problems with the known markers is that the eraser is a piece that is separate from the markers and which results in that the eraser is frequently very hard to find because someone had removed it or that it was misplaced in an inadequate place. In this way, the eraser is not always available to the user to erase the writing surface. In a similar way, the markers can be removed or easily placed in different place within the work zone close to the board, provoking that the users has to move from one side to the other in order to reach desired marker in said moment, especially in order to use many combinations of colors, which is one of the more useful characteristics of the white board.

To solve the problem of the removal and misplacement of the markers and the eraser, many alternatives have been proposed. Such as the U.S. Pat. No. 3,110,917 (McPeek Jr., 1963), which describes an eraser in the form of a prismatic bar with one face containing the erasing element, and the opposite face offering holes designed to hold 3 sticks of chalk, which are maintained in place by a sliding lid that covers them when access is not required; the eraser also includes a magnet that allows for the attachment to a metallic support fixed to the wall.

The U.S. Pat. No. 5,432,973 (Wagner et al, 1995) describes a device a little more practical and appropriate for the instruments used with white boards. It is made up of a system of erasing especially adapted for white boards, that has a first means of erasing, such as a pile of cloths, and as a second means of erasing hard to remove marks, such as Velcro, the eraser also includes a sleeve designed to hold up to three markers.

This sleeve has projections with corners in right angles that form three slots along the length of the eraser where a marker can be placed in one of the slots; it seems that the removal of one of the markers only can be done by taking the ends and placing outward pressure on the slot. The design seems to be uncomfortable for the user, especially because of the presence of the sharp corners, and because there is only one line of support for the sleeve, it seems fragile, requiring the material used in its fabrication to be sufficiently flexible which at the same time produces only a little strength in the eraser.

The design proposed by Krapf (U.S. Pat. No. D398,644, 1998) partially resolves the problem of the sharps corners as was in Wagner's design, and it also allows for the lodging of writing instruments of diverse dimensions, such as markers and skinny markers. Nonetheless, the design still presents the problems of stability associated with only one line of attachment between the body of the eraser and the sleeve of the marker case.

The U.S. Pat. No. 6,305,864 (Nguyen, 2001), not directed at a conjunction of an eraser and markers, offers an interesting solution to the problem of the finding the writing instruments. Upon providing a system based on a suction cup configuration to be pressed against a flat surface, the cup includes a localized connector on the exterior of the convex surface and said connector is joined with a hole especially designed in the base of the writing instrument in a way so that said instrument can be placed on any flat surface with the help of the suction cup. This alternative is fairly practical when it is compared with the differences it has to McPeek's device, such that it doesn't need a metal support fixed to a wall to be able to find the article in question, nonetheless it does have the limitation of not being able to hold more than one article at a time.

Unlike Nguyen's device, Hawkins, U.S. Pat. No. 7,309,181, proposes an eraser for the white board that has an upper region and a lower region, a layer of eraser material that has an upper section and a lower section, where the upper section is fixed to the lower region of the body of the eraser, and the eraser has at least one hole in the upper region to accommodate at least one unit of writing utensils, and a magnetic element connected in a functional way to the body of the eraser between the upper section of the layer of eraser material and the upper region of the body of the eraser. Nonetheless, even when Hawkins's article can hold more than one writing utensil and has the possibilities to be attached to a magnetic surface, like the majority of the boards, the design is such that when the writing utensils are found to be in their positions over the body of the eraser, they disturb the user.

### OBJECTS OF THE INVENTION

In view of the limitations that the proposed developments have presented up until now as explained in the previous part, the present invention has as its objective to provide an article that simultaneously holds an eraser and various markers special for use on white boards.

Another objective of the present invention is to provide an eraser and marker holder that allows easy access to, and easy release of the eraser and one or more of the markers on its interior.

Still another objective of the invention is to provide an eraser and marker holder that is easily positionable close to the white board in use.

One more objective of the invention is to provide an eraser and marker holder that is easily attachable, and easy to remove, with close proximity to the board in use.

These and other objectives and advantages of the present invention will be made evident in the following description, which is accompanied by a series of figures for the preferred embodiments of the invention, that should be understood with the purpose of being illustrative and are not to be limiting to the teachings of the invention.

### BRIEF DESCRIPTION OF THE INVENTION

The present invention is related to a useful article for the storage and the transportation of an eraser and various markers for white board, and that furthermore, has means to be able to be hung in a removable way in proximity to the board in use, such as the user can quickly and easily access the writing instruments and eraser, and remove the object when it is no longer necessary for the instruments to be in use.

The article of the invention includes means of attachment for an eraser in a rectangular section, which will hold the eraser against the base of the article by sustaining it in three points along its edges. Two of these points are situated along one edge of the eraser and the third is located in the middle of the opposite side. It is easy to free from the means of attachment by placing pressure on the release button.

Additionally, the device of the invention offers three approximately semicircular slots with means of attachment on both opposite side for the internal face of each slot to retain other markers for the white board. They will be able to be easily released by twisting the group of slots in such a way that the opposite sides of the internal face of the slot in question opens enough so that the means of attachment allows the release of the body of the marker. These three slots are located on a side of the section of the eraser holder in a way that one of the extremes of the group of slots is located in the middle of the two points of attachment of the eraser previously described, extending the group in the opposite direction from the location of the third point of attachment of the eraser.

The device has an opening located in the base of the eraser holder with dimensions such that it allows the passage and the holding in place of the means of support of the device in order to hang in on a flat surface. The preferred means of support are of the type of a suction cup that allows it to be applied on any type of surface that is sufficiently smooth, such as a wall, the white board itself or a table with the purpose being to hold the object of the invention in a fixed place during the time that the user requires the use of the writing instruments and the eraser, and then, the removal of the object of the invention for its storage once the use of said instruments is no longer needed.

### BRIEF DESCRIPTION OF THE DRAWINGS

For a better understanding of the advantages of the system of the invention, a series of drawings and figures are presented. They illustratively show the preferred characteristics of the system, without being limiting of the same.

FIG. 1 is a simple perspective view of the eraser and marker holder, object of the invention.

FIG. 2 is a superior view of the eraser and marker holder, object of the invention.

FIG. 3 is a lateral view of the eraser and marker holder, object of the invention.

FIG. 4 is a superior view of the eraser and marker holder, object of the invention, with an eraser and three markers in their place of use in the object of the invention.

FIG. 5 is a lateral view of the eraser and marker holder, object of the invention, with an eraser and three markers in their place of use in the object of the invention

FIG. 6 is a sectional cut of the zone of the eraser holder of the eraser and marker holder, object of the invention, showing the location of the means of attachment and support to fix it to a smooth surface.

FIG. 7 is a lateral plane view of the preferred means of attachment and support to fix the eraser and marker holder, object of the invention to a smooth surface.

FIG. 8 is a perspective view of the preferred means of attachment and support to fix the eraser and marker holder, object of the invention to a smooth surface.

### DESCRIPTION OF THE INVENTION

The following description will be referring to the accompanying drawings previously described; they should be understood as illustrative of the preferred embodiments of the invention and not limiting to the scope of the inventive concept. The common elements in the figures have the same reference numbers in every figure.

The present invention refers to a device or an article for the storage and transportation of an eraser and various markers, with means of supporting said object on a smooth surface such as a wall, the white board itself, a table or other similar object, in a way such that the eraser as well as the markers are perfectly located for the users during a work session on the white board.

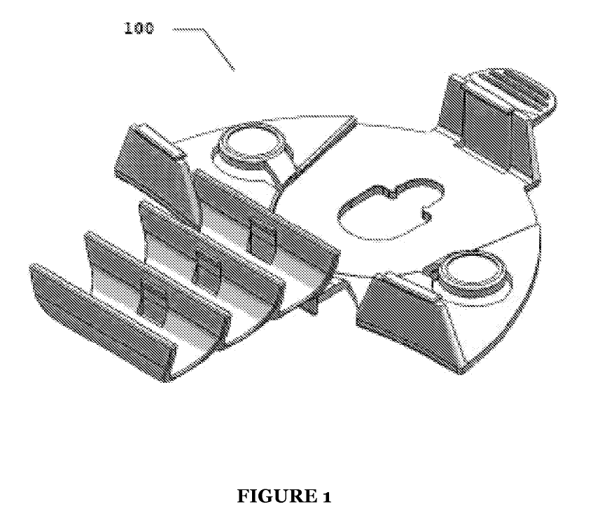

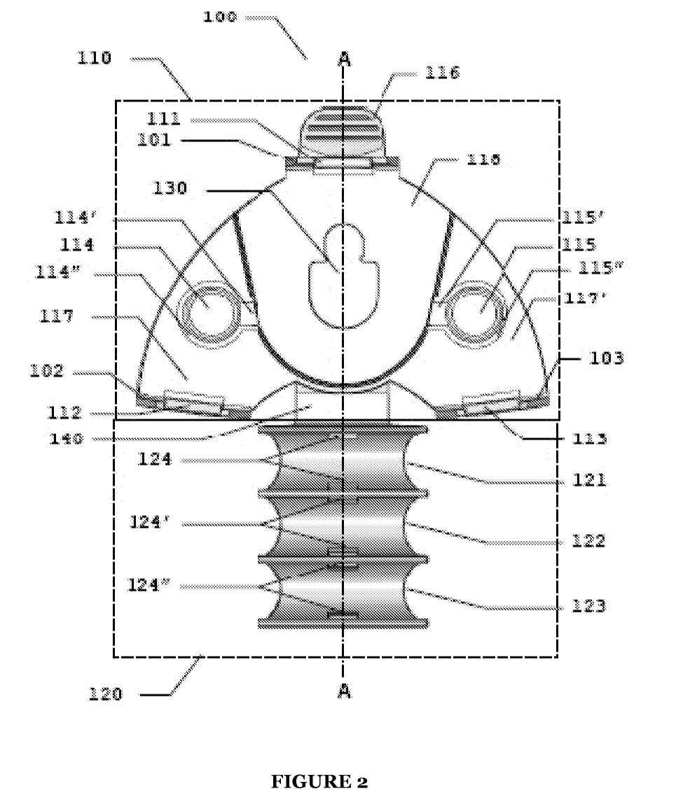

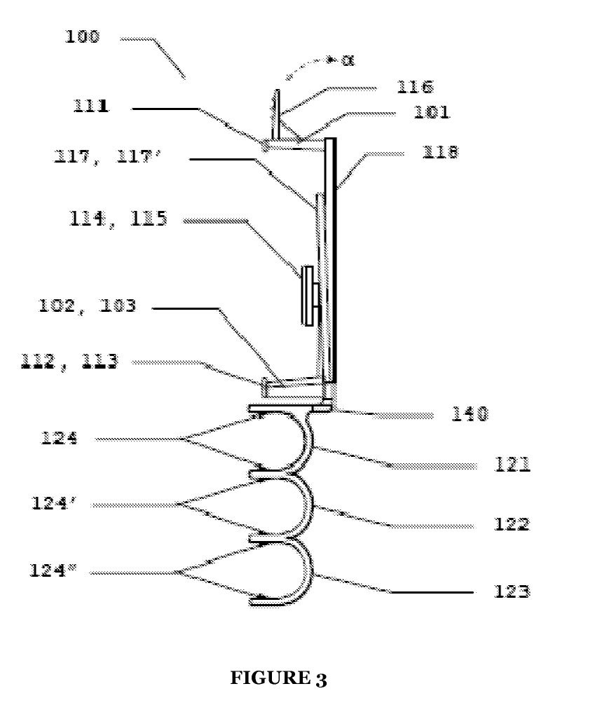

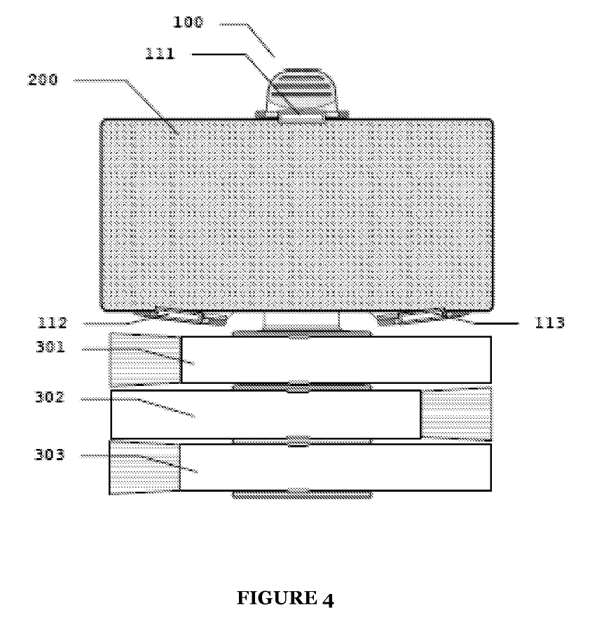

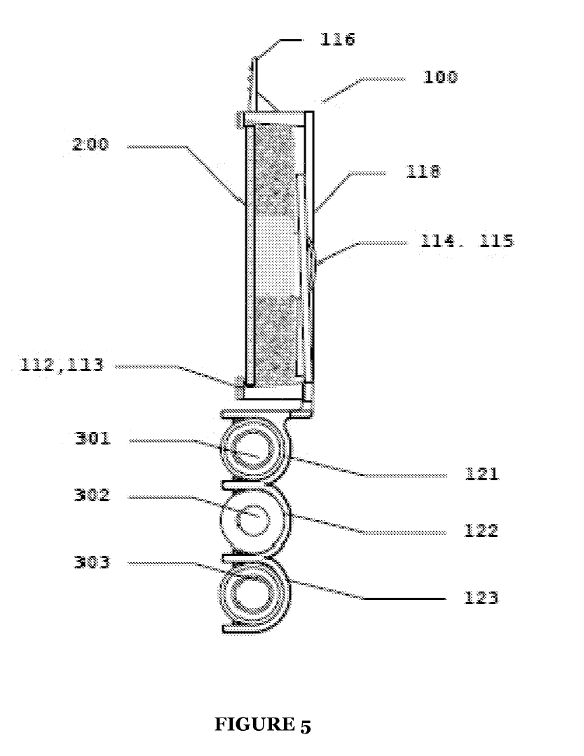

The device or the article of the invention is referred to in general by the number (100) in FIGS. 1 through 6; the elements of which it is composed appear better in FIGS. 2 and 3, including a first zone (110) of the eraser holder, defined by the upper border, designed to hold a conventional eraser (designated by number (200) in FIGS. 4 and 5, further ahead) for the white board and a second zone (120) for the marker holder, defined by the lower border, designed for holding multiple markers for the board, for example the type known as for the “white board”.

The first zone (110), including surfaces (117) and (117′) that serve as a support base for a conventional eraser, defined on the “lower” extreme with respect to the positioning of FIG. 2 of the vertical walls (102) and (103) in a trapezoidal form with the large base formed by the union with the surfaces (117) and (117′), preferably perpendicular to the central axis of A-A symmetry of the object (100) but that also an angle can be presented that allows the means of attachment to the walls of the eraser when it is placed in its position in the object (100) of the invention. If the contour of the surfaces (117) and (117′) do not interfere with the functionality of the object (100), it is recommended that these form an arc upon leaving the inferior extreme where the vertical walls (102) and (103) start to elevate to avoid angles that would represent risks to the users' skin or the papers that are in the area. The walls (117) and (117′) are limited in the zone oriented toward the center of the object (100) by a symmetrical arc that opens upward forming another surface of the base (118) that offers a slope in the same direction. It slopes in such a way that the upper extreme of the object's (100) surface is found to be out of place in respect to the plane formed by surfaces (117) and (117′) in a measurement that permits the body of the means of attachment for the object (100) to rest against it, as will be described shortly; this is evident in FIG. 3 that is a lateral view or a profile view of the object (100).

It can be observed that the contour of the surface (118) is a continuation of the arc defined by the edges of surfaces (117) and (117′) closing the arc with a vertical wall (101) just along the vertex from the arc in respect to the vertical walls (102) and (103). The wall (101) is completely perpendicular to the axis of symmetry A-A of the object (100) and in a trapezoidal form with the large base forming a union with the surface (118).

The three vertical walls (101), (102) and (103) present in the small bases, projections (111), (112) and (113) that project out toward the interior of the zone defined by the surfaces (117), (117′) and (118). These projections, preferably of a rectangular section, are designed to hold the edges of the body of the eraser that it is going to carry, holding it in three points. The distances between the wall (101) and the walls (102) and (103) should be that of the width of conventional eraser in such a way that the projections (111), (112) and (113) lightly attach over the eraser, as is illustrated in FIGS. 4 and 5.

Contributing to holding the eraser in the zone (110) and to avoid the eraser slipping up or down over the walls, in such a way that the edges can avoid the attachment by the projections (111), (112) and (113,) it includes elements of attachment formed by two areas (114) and (115), cut from the lateral surfaces (117) and (117′), attached to the surface (118) by means of two tongues (114′) and (115′) respectively, that freely move through the openings (114″) and (115″) that correspond to them, placed in the lateral surfaces (117) and (117′) and originally projecting on top of the plane defined by said lateral surfaces (117) and (117′) making the functions of the walls that compress the body of the conventional eraser located in the area of the eraser holder (110) of article (100) against the projections (111), (112) and (113), holding it and inhibiting its movement.

To release the eraser, and take advantage of the flexibility that the object (100) has, as for the material of fabrication as well as for the design, there is a button like tongue (116) with a textured surface, that allows the wall (101) to flex and move in the direction indicated by the arrow “a” in FIG. 3, freeing the eraser from the projection (111) upon applying a gentle force on said texturized surface of said bottom like tongue (116); in this way, the eraser, thus liberated on one of its edges, can be removed from the zone (110).

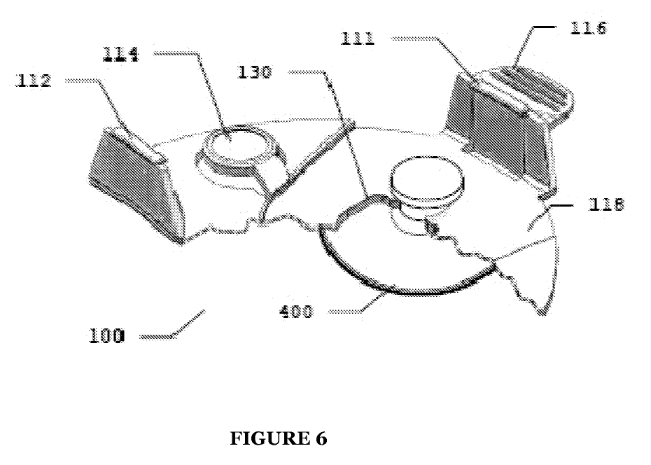

The surface (118) also offers a perforation (130) to hold and attach means of support to attach, support, or fix the object temporarily on a smooth surface, such as a wall, the board itself, or a table. The perforation (130) of the surface (118) has a first section located towards the bottom of FIG. 2 with a form and dimensions such that allow the free passage of the support (410) of the means of attachment, such as a suction cup (400); a second section of the perforation (130) located towards the top in FIG. 2, has the dimensions and form such that it can hold the neck (420) of the suction cup (400) and can hold it in place due to the narrowing between said two sections of the perforation (130) formed by the projections. The narrow section only allows the passage of the neck (420) of the suction cup (400) upon exerting a certain amount of strength and the deformation of the material as is schematically illustrated in the cut of FIG. 6.

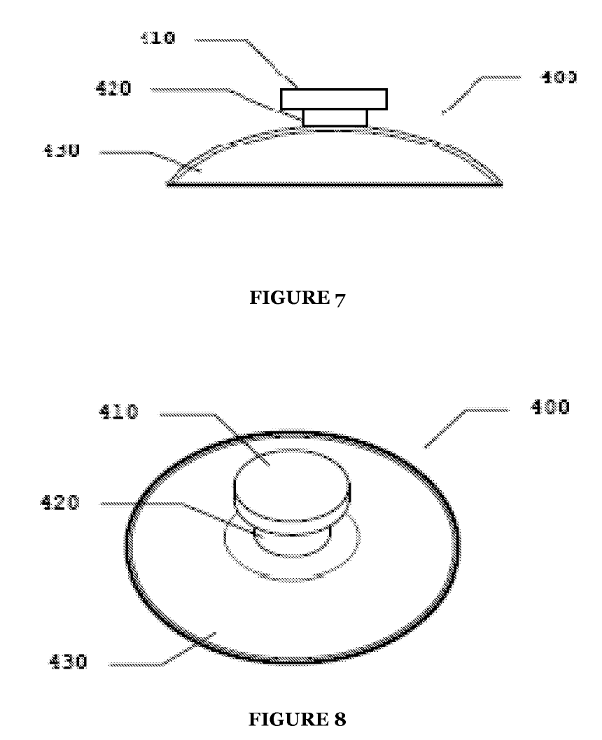

As was mentioned in the previous paragraph, the preferred embodiment of means of support is by use of a suction cup, as is schematically illustrated in FIGS. 7 and 8 and referred to by the number (400); this conventional suction cup (400) is formed by a body of the cup (430) and a body of attachment (410) joined by a neck (420) all of which is formed all of the same material.

With respect to the marker holding zone (120) in FIG. 2, it is composed of multiple grooves with a transversal section in a form of a “U” denoted by the numbers (121), (122) and (123) as it is clearly shown in FIGS. 2 and 3; said grooves are found to be joined by a common wall between each pair. In the figures, the model of the object (100) of the invention is illustrated with three of these grooves. The grooves (121), (122) and (123) because of the “U” shaped form have lateral walls that have both extremes open; in these walls, there are found pairs of projections (124), (124′) and (124″) opposite from one another, one pair per groove, and with a profile that defines the continuation of the curved wall of each groove, in a way that perfectly accommodates the cylindrical bodies of many dry erase markers (301), (302) and (303), as is illustrated in FIG. 5. Due to the fact that the markers generally are not perfect cylinders, the insertion of the same in the corresponding grooves (121), (122) and (123) can be slightly difficult to accommodate due to their configuration. For that reason, an alternating arrangement of the orientation of the markers is needed, with the purpose to compensate the deformation as is illustrated in FIG. 4. To release a specific marker, it is enough to pull on its extremes, with a light force so that the body of the marker passes the projections (124) of the respective groove; this is possible thanks to the flexibility of the material as well as the geometry of the group of grooves, that have slight flexibility of the group in order to separate the extremes of the “U” of one or various grooves.

Finally, the zones (110) and (120) are joined by a tongue (140).

Not only does the design of the object of the invention allows it to flex sufficiently to accommodate, hold and free the eraser and the markers, it is also important to point out that the walls are thin, although sufficiently thick enough to avoid the material breaking for fatigue. The material itself is preferably rigid but with a certain amount of flexibility.

Considering the previous description, it would be evident for a person with knowledge in the field that some modification to the basic configuration of the article illustrated could be necessary to satisfy specific requirements, but it should be taken into consideration that these modifications will not take the invention farther than described in the following claims. It is also clear the reference to the white boards and associated markers, should not be limiting, and anytime that there are other devices for writing, that include the electronic boards, panels of plastic or crystal, touch screens, etc. that use similar instruments to said markers and erasers, for that which the device of the invention can be used, with little or no additional adaption to the general configuration.

What is claimed is:

1. An eraser and marker holder to store and move one eraser and many markers, this article is characterized by
a) an eraser holding zone which has means of attachment to fasten one eraser; and
b) a second zone designed to store markers having a plurality of grooves and means of attachment to fasten the markers;
c) a beam that joins the eraser holding zone with the marker holding zone;
the first eraser holding zone is provided with a central hole that allows the insertion of removable means of attaching this article to a flat surface.

2. The eraser and marker holder as referred to in claim 1, wherein the first said zone of the eraser holding zone it is formed by two lateral surfaces that form a single plane to store a conventional eraser, and one flat surface that is located between the lateral surfaces, with an inclination with respect to the plane formed by the two said lateral surfaces, in order to allow the presence of the element that holds this article to a flat surface.

3. The eraser and marker holder as referred to in claim 1, wherein said lateral surfaces of the first zone of the eraser carrier, includes vertical walls with projections on their top that point to the center of the mentioned eraser holding zone, in order to hold the eraser, those vertical walls are located at the end near to the where it joins with the marker holder.

4. The eraser and marker holder as referred to in claim 2, wherein said lateral surfaces of the first zone of the eraser carrier, includes vertical walls with projections on their top that point to the center of the mentioned eraser holding zone, in order to hold the eraser, those vertical walls are located at the end near to the where it joins with the marker holder.

5. The eraser and marker holder as referred to in claim 1, wherein said central surface of the eraser holding zone has a vertical wall with a projection on its top that points to the eraser holding zone, in order to hold an eraser inthere, said vertical wall is located at the opposite end of where it joins to the marker holding zone.

6. The eraser and marker holder as referred to in claim 2, wherein said central surface of the eraser holding zone has a vertical wall with a projection on its top that points to the eraser holding zone, in order to hold an eraser inthere, said vertical wall is located at the opposite end of where it joins to the marker holding zone.

7. The eraser and marker holder as referred to in claim 3, wherein said central surface of the eraser holding zone has a vertical wall with a projection on its top that points to the eraser holding zone, in order to hold an eraser inthere, said vertical wall is located at the opposite end of where it joins to the marker holding zone.

8. An eraser and marker holder as referred to in claim 3, wherein the vertical walls have a trapezoidal shape, with the longest bases join to the lateral surfaces of the eraser holding zone.

9. An eraser and marker holder as referred to in claim 5, wherein the vertical walls have a trapezoidal shape, with the longest bases join to the lateral surfaces of the eraser holding zone.

10. An eraser and marker holder as referred to in claim 3, wherein vertical walls with projections on them are located on the base of said vertical walls, projecting toward the center of the eraser holding zone, all together, therefore are three support points to hold an eraser when it is set in the eraser holding zone, and is delimited by the flat surfaces and the vertical walls, and where said projections preferably have a rectangular section.

11. An eraser and marker holder as referred to in claim 5, wherein vertical walls with projections on them are located on the base of said vertical walls, projecting toward the center of the eraser holding zone, all together, therefore are three support points to hold an eraser when it is set in the eraser holding zone, and is delimited by the flat surfaces and the vertical walls, and where said projections preferably have a rectangular section.

12. An eraser and marker holder as referred to in claim 8, wherein vertical walls with projections on them are located on the base of said vertical walls, projecting toward the center of the eraser holding zone, all together, therefore are three support points to hold an eraser when it is set in the eraser holding zone, and is delimited by the flat surfaces and the vertical walls, and where said projections preferably have a rectangular section.

13. The eraser and marker holder as referred to in claim 5, wherein a button as a tongue is located on the vertical wall that is opposite from the projection that holds the eraser, and where such button allows the user to apply gentle force to bend such vertical wall and release the eraser that was originally held by the three projections on the three vertical walls.

14. The eraser and marker holder as referred to in claim 1, wherein said lateral and central surfaces of said zone of the eraser carrier preferably show all together a semicircular outline, with the base including two of the vertical walls pointing towards the union with the marker holding zone and the vertex opposite from the third vertical wall.

15. The eraser and marker holder as referred to in claim 14, wherein the distance between the two vertical walls close to the joint between the eraser holding zone and marker holding zone and the opposite vertical wall is have the necessary width to hold the average conventional blackboard eraser.

16. The eraser and marker holder as referred to in claim 1, wherein the mentioned lateral surfaces of the eraser holding zone have hanging elements that push the body of an eraser against the vertical wall's projections set in eraser's holding zone in order to offer a better hold of the eraser.

17. The eraser and marker holder as referred to in claim 10, wherein the mentioned lateral surfaces of the eraser holding zone have hanging elements that push the body of an eraser against the vertical wall's projections set in eraser's holding zone in order to offer a better hold of the eraser.

18. The eraser and marker holder as referred to in claim 16, wherein the elements of attachment are made up of small cut areas coming from lateral surfaces and joined to the central surface by a beam that allows movement through the hole working as spring; such cut surfaces are located over the plane defined by the lateral surfaces.

19. The eraser and marker holder as referred to in claim 1, wherein the hole used to allow the removable insertion of the means of attachment of this object to a flat surface is located in the first eraser holding zone on the central surface and is centered along the axis of symmetry this article.

20. The eraser and marker holder as referred to in claim 2, wherein the hole used to allow the removable insertion of the means of attachment of this object to a flat surface is located in the first eraser holding zone on the central surface and is centered along the axis of symmetry this article.

21. The eraser and marker holder as referred to in claim 19, wherein said hole it is made up by two gaps joined between them a narrowing that happens between both gaps; the first gap allows the passage of the means of attachment to attach the object to a surface and the second gap only allows and holds a reduced-width zone of mentioned means of attachment once it passed through the reduction; the hole is preferably symmetrical.

22. The eraser and marker holder as referred to in claim 1, wherein it has a marker holding zone that is built up by a plurality of “U” shaped parallel grooves that are joined in pairs, with each pair sharing one of the walls of the “U”.

23. The eraser and marker holder as referred to in claim 22, wherein the marker holding zone in each of the mentioned grooves, located in the zone close to the top edge of the “U”, has projections to the interior, allowing the passage of the cylindrical body of a marker, when enough pressure is applied, the “U” branches open, and block the passage of mentioned marker's body once the forced applied is gone.
